(19) United States
(12) Patent Application Publication
(10) Pub. No.: US 2024/0116155 A1
(43) Pub. Date: Apr. 11, 2024

(54) Magnetic Wrench

(71) Applicant: Mike Balmes, Pleasant Praire, WI (US)

(72) Inventor: Mike Balmes, Pleasant Praire, WI (US)

(21) Appl. No.: 17/961,284

(22) Filed: Oct. 6, 2022

(51) Int. Cl. B25B 13/48

(52) U.S. Cl. CPC B25B 13/48

(57) ABSTRACT

A magnetic wrench includes a cutting die that has a rubber surround and the rubber surround has a fastener well. A fastener is insertable into the fastener well in the rubber surround and the fastener includes a head. A tool is provided which has a handle, a shaft extending away from the handle and a magnet that is disposed on the shaft. The shaft is insertable into the fastener well in the rubber surround thereby facilitating the magnet to magnetically engage the fastener in the fastener well in the rubber surround. In this way the tool facilitates the user to tighten or loosen the fastener without requiring the fastener to be gripped.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to wrench devices and more particularly pertains to a new wrench device for tightening or loosening fasteners in a cutting die. The device includes a tool which includes a handle, a shaft and a magnet disposed on the shaft. The magnet has a magnetic strength that is sufficient to break free of a fastener once the fastener has been approximately hand tightened. In this way a fastener in a cutting die can be tightened or loosened in a fastener well of the cutting die.

### (2) Description of Related Art Including Information Disclosed Under 37 CFR 1.97 and 1.98

The prior art relates to wrench devices including an electromagnetic retrieval toll that includes an electromagnet disposed within a probe and a pistol grip. The prior art discloses a magnetic retrieval tool which includes a tube and a magnet retractably disposed in the tube. The prior art discloses a variety of telescopic retrieval tools which each at least includes a telescopic shaft and a magnet disposed on an end of the telescopic shaft.

### BRIEF SUMMARY OF THE INVENTION

An embodiment of the disclosure meets the needs presented above by generally comprising a cutting die that has a rubber surround and the rubber surround has a fastener well. A fastener is insertable into the fastener well in the rubber surround and the fastener includes a head. A tool is provided which has a handle, a shaft extending away from the handle and a magnet that is disposed on the shaft. The shaft is insertable into the fastener well in the rubber surround thereby facilitating the magnet to magnetically engage the fastener in the fastener well in the rubber surround. In this way the tool facilitates the user to tighten or loosen the fastener without requiring the fastener to be gripped.

An additional embodiment of the disclosure meets the needs presented above by generally comprising a method of tightening or loosening a fastener in a cutting die which includes the steps of providing a cutting die has a rubber surround which has a fastener well. The steps include providing a fastener that has a head and the fastener is insertable into the fastener well in the rubber surround. The steps include providing a tool that has a handle, a shaft extending away from the handle and a magnet that is attached to a distal end of the shaft which has a lower end. The steps include inserting the shaft into the fastener well in the rubber surround thereby facilitating the lower end of the magnet to magnetically engage the head of the fastener in the fastener well in the rubber surround. The steps include rotating the handle thereby facilitating the fastener in the fastener well in the rubber surround to be tightened or loosened.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a magnetic wrench according to an embodiment of the disclosure.

FIG. 2 is a bottom view of an embodiment of the disclosure.

FIG. 3 is a cross sectional view of an embodiment of the disclosure.

FIG. 4 is a perspective in-use view of an embodiment of the disclosure.

### DETAILED DESCRIPTION OF THE INVENTION

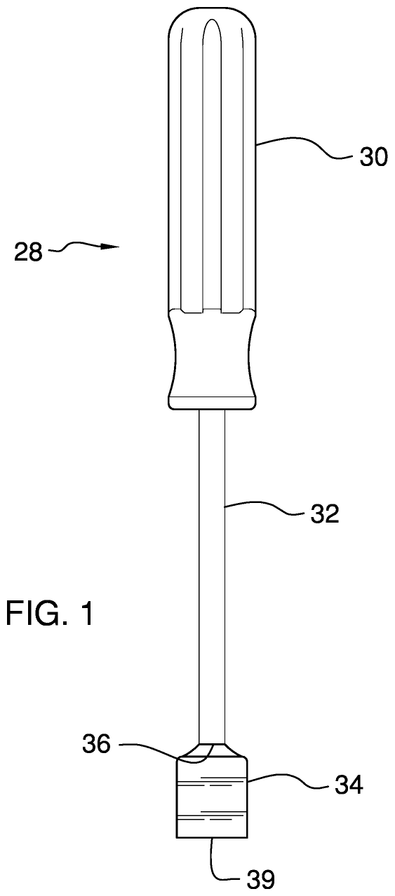

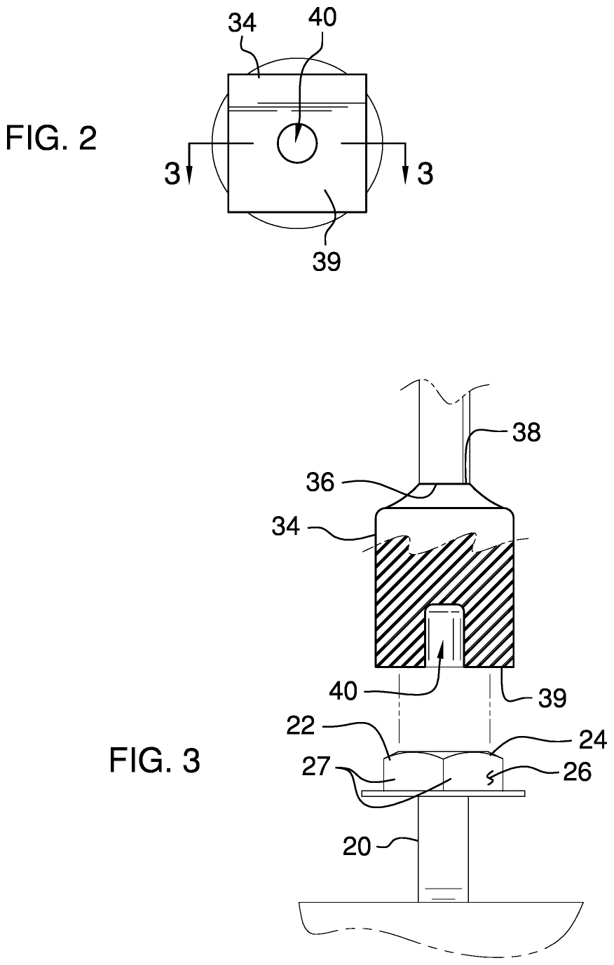

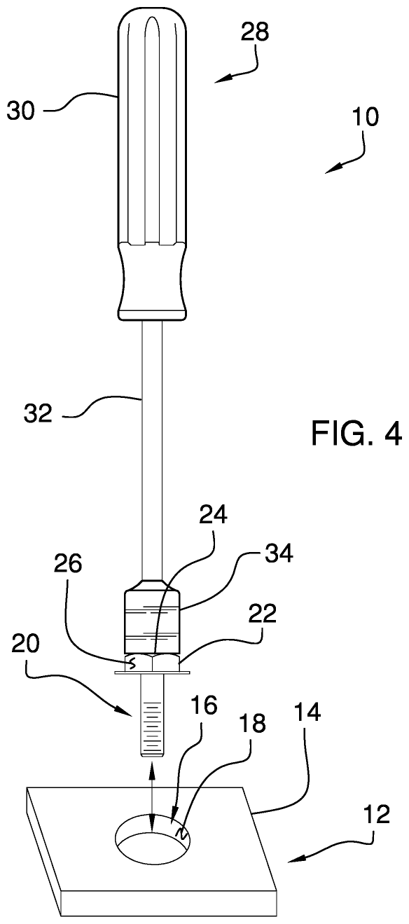

With reference now to the drawings, and in particular to FIGS. 1 through 4 thereof, a new wrench device embodying the principles and concepts of an embodiment of the disclosure and generally designated by the reference numeral 10 will be described.

As best illustrated in FIGS. 1 through 4, the magnetic wrench 10 generally comprises a cutting die 12 that has a rubber surround 14. The rubber surround 14 has a fastener well 16 and the fastener well 16 has a bounding surface 18. The cutting die 12 may be mounted to a cylinder that is rotated by a machine in a manufacturing environment. A fastener 20 is insertable into the fastener well 16 in the rubber surround 14 and the fastener 20 includes a head 22. The head 22 of the fastener 20 has a top surface 24 and a perimeter surface 26, and the perimeter surface 26 may be continuously arcuate about a center of the top surface 24 or the perimeter surface 26 may have a plurality of intersecting sides 27. Furthermore, the perimeter surface 26 of the head 22 the fastener 20 defines a circle that has a diameter which is slightly less than a diameter defined by the bounding surface 18 of the fastener well 16. Thus, the perimeter surface 26 of the head 22 is inaccessible to a user's fingers when the fastener 20 is inserted into the fastener well 16 in the rubber surround 14. Additionally, the clearance between the perimeter surface 26 of the head 22 and the bounding surface 18 of the fastener well 16 is insufficient to facilitate a socket of a socket wrench to be positioned on the head 22 of the fastener 20.

A tool 28 is provided which has a handle 30, a shaft 32 extending away from the handle 30 and a magnet 34 that is disposed on the shaft 32. The shaft 32 is insertable into the fastener well 16 in the rubber surround 14 thereby facilitating the magnet 34 to magnetically engage the fastener 20 in the fastener well 16 in the rubber surround 14. In this way the tool 28 facilitates the user to tighten or loosen the fastener 20 without requiring the fastener 20 to be gripped. The shaft 32 is comprised of a rigid material, including but not being limited to steel or aluminum. Additionally, the magnet 34 may comprise a neodymium magnet which has a magnetic force sufficient to engage the fastener 20 to tighten the fastener 20 to a torque that is approximately equivalent to the torque an average person can apply by hand tightening the fastener 20. In this way the fastener 20 can be approximately hand tightened while still facilitating the magnet 34 to be disengaged from the fastener 20 when the fastener 20 has been approximately hand tightened. The fastener 20 may comprise a hex head bolt that is comprised of a ferromagnetic material.

The shaft 32 has a distal end 36 with respect to the handle 30 and the magnet 34 has a top end 38 and a bottom end 39. The top end 38 is attached to the distal end 36 of the handle 30 and the bottom end 39 has a well 40 extending toward the top end 38. Additionally, the well 40 in the bottom end 39 is centrally positioned on the bottom end 39. The bottom end 39 magnetically engages the top surface 24 of the head 22 of the fastener 20 in the fastener well 16 in the rubber surround 14 when the shaft 32 is inserted into the fastener well 16. In this way the tool 28 can tighten or loosen the fastener 20 in the fastener well 16 without engaging the perimeter surface 26 of the head 22 of the fastener 20 in the fastener well 16 in the rubber surround 14. The shaft 32 may have a length ranging between approximately 12.0 mm and 50.0 mm. The magnet 34 may have a length and a width ranging between approximately 12.0 mm and 24.0 mm.

In use, the handle 30 of the tool 28 is gripped and the shaft 32 is inserted into the fastener well 16 in the rubber surround 14 such that the magnet 34 magnetically engages the head 22 of the fastener 20 in the fastener well 16. In this way the fastener 20 can be loosened to remove the fastener 20 from the fastener well 16. Additionally, the magnet 34 facilitates the fastener 20 to be removed from the fastener well 16 once the fastener 20 is fully loosened. The fastener 20 can be dropped into the fastener well 16 and the shaft 32 can be inserted into the fastener well 16 such that the magnet 34 magnetically engages the head 22 of the fastener 20. Thus, the fastener 20 can be tightened for securing the cutting die 12 in place. Furthermore, the magnet 34 releases the head 22 of the fastener once the fastener 20 is tightened to a torque that is approximately equivalent to being hand tightened. In this way the fastener 20 is inhibited from being over tightened and potentially damaging the cutting die 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A magnetic wrench assembly for tightening or loosening fasteners in a rotary die, said assembly comprising:
a cutting die having a rubber surround, said rubber surround having a fastener well;
a fastener being insertable into said fastener well in a said rubber surround, said fastener including a head; and
a tool having a handle, a shaft extending away from said handle and a magnet being disposed on said shaft, said shaft being insertable into said fastener well in said rubber surround thereby facilitating said magnet to magnetically engage said fastener in said fastener well said rubber surround wherein said tool is configured to facilitate the user to tighten or loosen said fastener without requiring said fastener to be gripped.

2. The assembly according to claim 1, wherein:
said fastener well in said rubber surround has a bounding surface; and
said head of said fastener has a top surface and a perimeter surface, said perimeter surface being continuously arcuate about a center of said top surface, said perimeter surface of said head defining a circle having a diameter being slightly less than a diameter defined by said bounding surface of said fastener well such that said perimeter surface of said head is inaccessible to a user's fingers when said fasteners are inserted into said fastener well in said rubber surround.

3. The assembly according to claim 1, wherein:
said shaft has a distal end with respect to said handle;
said magnet has a top end and a bottom end, said top end being attached to said distal end of said handle; and
said bottom end has a well extending toward said top end, said well in said bottom end being centrally positioned on said bottom end.

4. The assembly according to claim 2, wherein a bottom end of said magnet magnetically engages said top surface of said head of said fastener in said fastener well in said rubber surround when said shaft is inserted into said fastener well in said rubber surround thereby facilitating said tool to tighten or loosen said fastener in said fastener well in said rubber surround without engaging said perimeter surface of said head of said fastener in said fastener wall in said rubber surround.

5. A magnetic wrench assembly for tightening or loosening fasteners in a rotary die, said assembly comprising:
a cutting die having a rubber surround, said rubber surround having a fastener well, said fastener well having a bounding surface;
a fastener being insertable into said fastener well in said rubber surround, said fastener including a head, said head of said fastener having a top surface and a perimeter surface, said perimeter surface being continuously arcuate about a center of said top surface, said perimeter surface of said head said fastener defining a circle having a diameter being slightly less than a diameter defined by said bounding surface of said fastener well such that said perimeter surface of said head is inaccessible to a user's fingers when said fastener is inserted into said fastener well in said rubber surround; and
a tool having a handle, a shaft extending away from said handle and a magnet being disposed on said shaft, said shaft being insertable into said fastener well in said rubber surround thereby facilitating said magnet to magnetically engage said fastener in said fastener well in said rubber surround wherein said tool is configured to facilitate the user to tighten or loosen said fastener without requiring said fastener to be gripped, said shaft having a distal end with respect to said handle, said magnet having a top end and a bottom end, said top end being attached to said distal end of said handle, said bottom end having a well extending toward said top end, said well in said bottom end being centrally positioned on said bottom end, said bottom end magnetically engaging said top surface of said head of said fastener in said fastener well in said rubber surround when said shaft is inserted into said fastener well thereby facilitating said tool to tighten or loosen said fastener in said fastener well without engaging said perimeter surface of said head of said fastener in said fastener well in said rubber surround.

6. A method of tightening or loosening a fastener in a rubber surround of a cutting die, the steps of the method comprising:
providing a cutting die having a rubber surround, said rubber surround having a fastener well;
providing a fastener having a head, said fastener being insertable into said fastener well in said rubber surround;
providing a tool having a handle, a shaft extending away from said handle and a magnet being attached to a distal end of said shaft, said magnet having a lower end;
inserting said shaft into said fastener well in said rubber surround thereby facilitating said lower end of said magnet to magnetically engage said head of said fastener in said fastener well in said rubber surround; and
rotating said handle thereby facilitating said fastener in said fastener well in said rubber surround to be tightened or loosened.
